(19) United States
(12) Patent Application Publication
(10) Pub. No.: US 2006/0217924 A1
(43) Pub. Date: Sep. 28, 2006

(54) Batch processing method and system

(75) Inventors: Gary Anderson, West Chester, PA (US); Robert Bergelson, Philadelphia, PA (US)

Correspondence Address: GROSSMAN, TUCKER, PERREAULT & PFLEGER, PLLC, 55 SOUTH COMMERICAL STREET, MANCHESTER, NH, 03101, US

(73) Assignee: Torc Technologies, LLC, Philadelphia, PA (US)

(21) Appl. No.: 11/286,990

(22) Filed: Nov. 23, 2005

Related U.S. Application Data
(60) Provisional application No. 60/630,307, filed on Nov. 23, 2004.
(60) Provisional application No. 60/630,291, filed on Nov. 23, 2004.
(60) Provisional application No. 60/630,375, filed on Nov. 23, 2004.
(60) Provisional application No. 60/630,315, filed on Nov. 23, 2004.
(60) Provisional application No. 60/630,290, filed on Nov. 23, 2004.
(60) Provisional application No. 60/630,374, filed on Nov. 23, 2004.
(60) Provisional application No. 60/630,472, filed on Nov. 23, 2004.
(60) Provisional application No. 60/630,309, filed on Nov. 23, 2004.
(60) Provisional application No. 60/630,308, filed on Nov. 23, 2004.

(51) Int. Cl. G06F 17/18

(52) U.S. Cl. 702/179

(57) ABSTRACT

A method, computer program product, and client computer for processing, for each of the plurality of option sets, a group of initial data points, such that each initial data point includes a strike price coordinate and a volatility coordinate. A best-fit curve is generated, on a single Cartesian plane and for each of the plurality of option sets, that is based, at least in part, upon two or more of the initial data points included within the respective group. Each best-fit curve defines a plurality of best-fit data points. Each best-fit data point includes a strike price coordinate and a volatility coordinate.

### RELATED APPLICATIONS

This application claims the priority of the following applications, which are herein incorporated by reference:

U.S. Provisional Application Ser. No.: 60/630,307, filed 23 Nov. 2004, entitled, “GRAPHICAL CURVE FITTING METHOD AND SYSTEM”;

U.S. Provisional Application Ser. No.: 60/630,291, filed 23 Nov. 2004, entitled, “BATCH PROCESSING METHOD AND SYSTEM”;

U.S. Provisional Application Ser. No.: 60/630,375, filed 23 Nov. 2004, entitled, “MULTI-PORTION DISPLAY METHOD AND SYSTEM”;

U.S. Provisional Application Ser. No.: 60/630,315, filed 23 Nov. 2004, entitled, “DELTA-T ORDER PROCESSING METHOD AND SYSTEM”;

U.S. Provisional Application Ser. No.: 60/630,290, filed 23 Nov. 2004, entitled, “DYNAMIC DESKTOP METHOD AND SYSTEM”;

U.S. Provisional Application Ser. No.: 60/630,374, filed 23 Nov. 2004, entitled, “RISK MANAGEMENT METHOD AND SYSTEM”;

U.S. Provisional Application Ser. No.: 60/630,472, filed 23 Nov. 2004, entitled, “DEDICATED MESSAGING METHOD AND SYSTEM”;

U.S. Provisional Application Ser. No.: 60/630,309, filed 23 Nov. 2004, entitled, “DELTA-$ ORDER PROCESSING METHOD AND SYSTEM”; and

U.S. Provisional Application Ser. No.: 60/630,308, filed 23 Nov. 2004, entitled, “REDUNDANT CURVE FITTING METHOD AND SYSTEM”.

### TECHNICAL FIELD

This disclosure relates to option management systems and, more particularly, to configurable option management systems.

### BACKGROUND

Option trading systems allow traders/managers to manage and trade option contracts. An option contract is the right, but not the obligation, to buy (i.e., a call option contract) or to sell (i.e., a put option contract) a specific amount of a given stock, commodity, currency, index, or debt, at a specified price (i.e., the strike price) during a specified period of time.

Each option contract has a buyer (i.e., a holder) and a seller (i.e., a the writer). If the option contract is exercised, the writer is responsible for fulfilling the terms of the contract by delivering the shares to the appropriate party. When the option contract is not exercised, the option contract expires. Accordingly, no shares change hands and the money spent to purchase the option contract is lost.

When trading and managing option contracts, each trader/manager tends to operate a little bit differently than other traders/managers when assessing e.g., volatility and risk. Unfortunately, option trading systems often tend to be rigid in structure and often do not allow the trader/manger to tailor the system to accommodate the unique proclivities of the trader/manager.

### SUMMARY OF THE DISCLOSURE

In one implementation, a method of batch processing a plurality of option sets includes processing, for each of the plurality of option sets, a group of initial data points, such that each initial data point includes a strike price coordinate and a volatility coordinate. A best-fit curve is generated, on a single Cartesian plane and for each of the plurality of option sets, that is based, at least in part, upon two or more of the initial data points included within the respective group. Each best-fit curve defines a plurality of best-fit data points. Each best-fit data point includes a strike price coordinate and a volatility coordinate.

One or more of the following features may also be included. The volatility coordinate of at least one of the initial data points may include a blended volatility coordinate. The volatility coordinate of at least one of the best-fit data points may include a blended volatility coordinate.

Generating, on a single Cartesian plane and for each of the plurality of option sets, a best-fit curve may include defining, for each of the plurality of option sets, the plurality of best-fit data points with a curve fitting algorithm. The curve fitting algorithm may include: one or more of: a least-squares algorithm; a weighted least-squares algorithm; a robust least-squares algorithm; and a non-linear least-squares algorithm.

A user may be allowed to graphically modify one or more of the best-fit data points to define one or more modified best-fit data points. Allowing a user to graphically modify one or more of the best-fit data points may include: allowing the user to graphically modify the volatility coordinate of one or more of the best-fit data points. Allowing a user to graphically modify one or more of the best-fit data points may include: allowing the user to graphically modify the strike price coordinate of one or more of the best-fit data points.

A weight may be assigned to at least one of the modified best-fit data points that is greater than a weight assigned to a corresponding best-fit data point. One or more of a theoretical call value and a theoretical put value may be calculated based, at least in part, upon one or more of the modified best-fit data points. A user may be allowed to define the plurality of option sets. Each of the plurality of option sets may define a unique chronological period.

In another implementation, a computer program product resides on a computer readable medium and has a plurality of instructions stored on it. When executed by a processor, these instructions cause the processor to perform operations including processing, for each of the plurality of option sets, a group of initial data points, such that each initial data point includes a strike price coordinate and a volatility coordinate. A best-fit curve is generated, on a single Cartesian plane and for each of the plurality of option sets, that is based, at least in part, upon two or more of the initial data points included within the respective group. Each best-fit curve defines a plurality of best-fit data points. Each best-fit data point includes a strike price coordinate and a volatility coordinate.

One or more of the following features may also be included. The volatility coordinate of at least one of the initial data points may include a blended volatility coordinate. The volatility coordinate of at least one of the best-fit data points may include a blended volatility coordinate.

Generating, on a single Cartesian plane and for each of the plurality of option sets, a best-fit curve may include defining, for each of the plurality of option sets, the plurality of best-fit data points with a curve fitting algorithm. The curve fitting algorithm may include: one or more of: a least-squares algorithm; a weighted least-squares algorithm; a robust least-squares algorithm; and a non-linear least-squares algorithm.

A user may be allowed to graphically modify one or more of the best-fit data points to define one or more modified best-fit data points. Allowing a user to graphically modify one or more of the best-fit data points may include: allowing the user to graphically modify the volatility coordinate of one or more of the best-fit data points. Allowing a user to graphically modify one or more of the best-fit data points may include: allowing the user to graphically modify the strike price coordinate of one or more of the best-fit data points.

A weight may be assigned to at least one of the modified best-fit data points that is greater than a weight assigned to a corresponding best-fit data point. One or more of a theoretical call value and a theoretical put value may be calculated based, at least in part, upon one or more of the modified best-fit data points. A user may be allowed to define the plurality of option sets. Each of the plurality of option sets may define a unique chronological period.

In another implementation, a client computer is configured to perform operations including processing, for each of the plurality of option sets, a group of initial data points, such that each initial data point includes a strike price coordinate and a volatility coordinate. A best-fit curve is generated, on a single Cartesian plane and for each of the plurality of option sets, that is based, at least in part, upon two or more of the initial data points included within the respective group. Each best-fit curve defines a plurality of best-fit data points. Each best-fit data point includes a strike price coordinate and a volatility coordinate.

One or more of the following features may also be included. The volatility coordinate of at least one of the initial data points may include a blended volatility coordinate. The volatility coordinate of at least one of the best-fit data points may include a blended volatility coordinate.

Generating, on a single Cartesian plane and for each of the plurality of option sets, a best-fit curve may include defining, for each of the plurality of option sets, the plurality of best-fit data points with a curve fitting algorithm. The curve fitting algorithm may include: one or more of: a least-squares algorithm; a weighted least-squares algorithm; a robust least-squares algorithm; and a non-linear least-squares algorithm.

A user may be allowed to graphically modify one or more of the best-fit data points to define one or more modified best-fit data points. Allowing a user to graphically modify one or more of the best-fit data points may include: allowing the user to graphically modify the volatility coordinate of one or more of the best-fit data points. Allowing a user to graphically modify one or more of the best-fit data points may include: allowing the user to graphically modify the strike price coordinate of one or more of the best-fit data points.

A weight may be assigned to at least one of the modified best-fit data points that is greater than a weight assigned to a corresponding best-fit data point. One or more of a theoretical call value and a theoretical put value may be calculated based, at least in part, upon one or more of the modified best-fit data points. A user may be allowed to define the plurality of option sets. Each of the plurality of option sets may define a unique chronological period.

The details of one or more implementations are set forth in the accompanying drawings and the description below. Other features and advantages will become apparent from the description and the drawings.

### BRIEF DESCRIPTION OF THE DRAWINGS

FIG. 1 is a diagrammatic view of an option management system coupled to a distributed computing network;

FIG. 2 is a diagrammatic view of a option management display screen rendered by the option management system of FIG. 1;

FIG. 3 is a diagrammatic view of a single-curve graph display screen rendered by the option management system of FIG. 1;

FIG. 4 is a diagrammatic view of a modified single-curve graph display screen rendered by the option management system of FIG. 1;

FIG. 5 is a flowchart of a process executed by the option management system of FIG. 1;

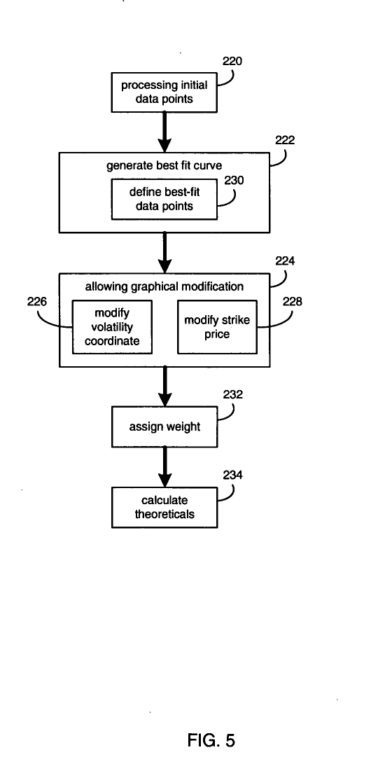

FIG. 6 is a diagrammatic view of a multi-curve graph display screen rendered by the option management system of FIG. 1;

FIG. 7 is a flowchart of a process executed by the option management system of FIG. 1;

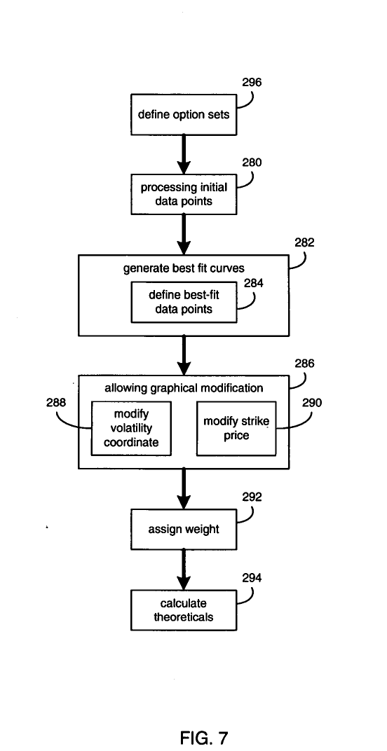

FIG. 8 is a flowchart of a process executed by the option management system of FIG. 1;

FIG. 9 is a flowchart of a process executed by the option management system of FIG. 1;

FIG. 10 is a flowchart of a process executed by the option management system of FIG. 1;

FIG. 11 is a flowchart of a process executed by the option management system of FIG. 1;

FIG. 12 is a diagrammatic view of a desktop display screen rendered by the option management system of FIG. 1; and

FIG. 13 is a flowchart of a process executed by the option management system of FIG. 1.

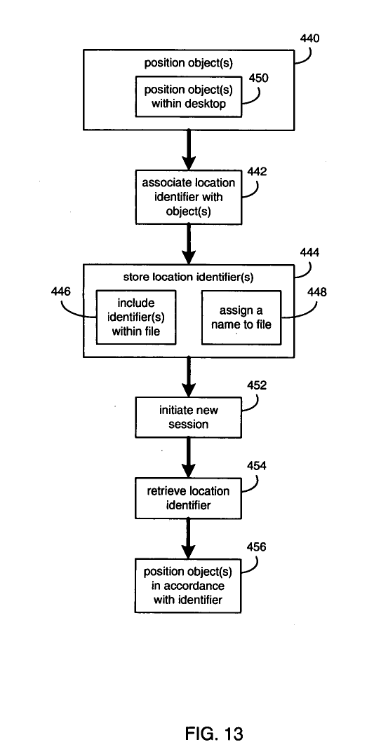

### DETAILED DESCRIPTION OF THE PREFERRED EMBODIMENTS

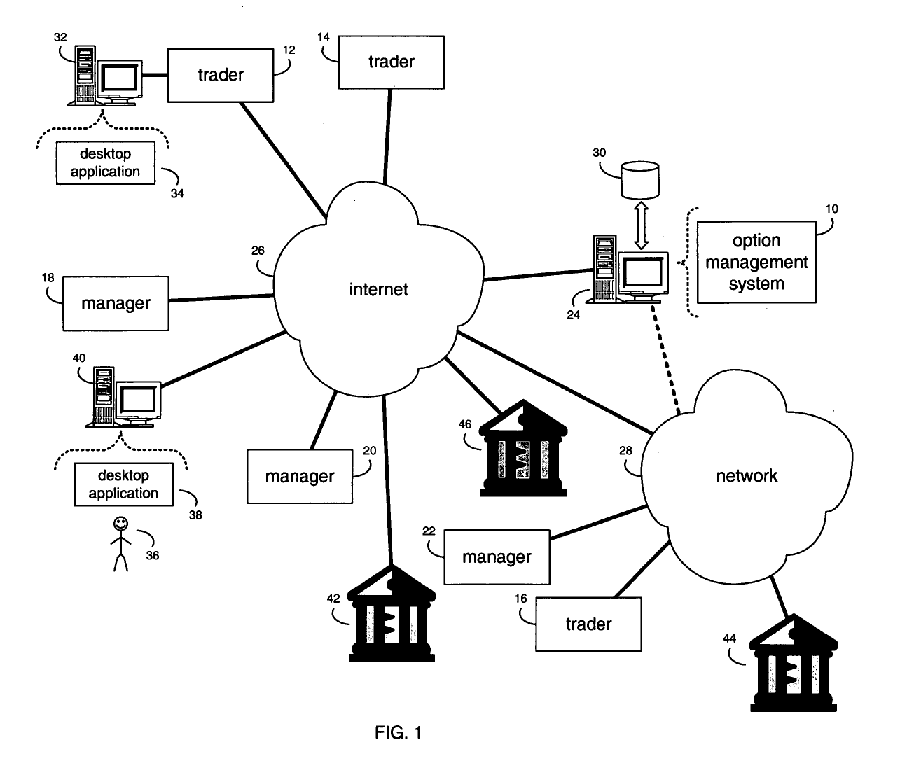

Referring to FIG. 1, there is shown an option management system 10 that may allow traders (e.g., traders 12, 14, 16) and managers (e.g., managers 18, 20, 22) to manage and trade options and graphically readjust the theoretical values of one or more options.

Option management system 10 may reside on and may be executed by a computer 24 that is connected to network 26 (e.g., the internet). Computer 24 may be a web server running a network operating system, such as Microsoft Window 2000 Server™, Novell Netware™, or Redhat Linux™. Computer 24 may also execute a web server application, such as Microsoft IIS™, Novell Webserver™, or Apache Webserver™, that may allow for HTTP (i.e., HyperText Transfer Protocol) access to computer 24 via network 26. Network 26 may be connected to one or more secondary networks (e.g., network 28), such as: a local area network; a wide area network; or an intranet, for example.

The instruction sets and subroutines of option management system 10, which may be stored on a storage device 30 coupled to computer 24, may be executed by one or more processors (not shown) and one or more memory architectures (not shown) incorporated into computer 24. Storage device 30 may be, for example, a hard disk drive, a tape drive, an optical drive, a RAID array, a random access memory (RAM), or a read-only memory (ROM).

Traders 12, 14, 16 and managers 18, 20, 22 may access option management system 10 directly through network 26 or through secondary network (e.g., network 28). Further, computer 24 (i.e., the computer that executes option management system 10) may be connected to network 26 through a secondary network (e.g., network 28).

Traders 12, 14, 16 and managers 18, 20, 22 may access option management system 10 through a computer (e.g., computer 32) that is connected to network 26 (or network 28) that executes a desktop application 34 (e.g., Microsoft Internet Explorer™, Netscape Navigator™, or a specialized interface).

An administrator 36 may access and administer option management system 10 through a desktop application 38 (e.g., Microsoft Internet Explorer™, Netscape Navigator™, or a specialized interface) running on an administrative computer 40 that may also be connected to network 26 (or network 28).

Option management system 10 may be directly or indirectly interfaced with one or more electronic securities exchanges (e.g., The NASDAQ™ stock market 42, the New York Stock Exchange™ 44, the Philadelphia Stock Exchange™ (not shown), or various ECN's (i.e., electronic communication networks) 46.

As stated above, option management system 10 may allow traders 12, 14, 16, and managers 18, 20, 22 to trade and manager various options. As is known in the art, an option is a contract that permits the owner, depending on the type of option held, to purchase or sell an asset at a fixed price until a specific date, such that an option to purchase an asset is a call and an option to sell an asset is a put.

The theoretical value of a particular option (i.e., the value at which an option should sell) may be calculated via a valuation algorithm, such as the Black-Scholes model or the Cox-Rubenstein model.

When determining the theoretical value of a call option using the Black-Scholes model, various values are entered into the following formula:
C=SN(d₁)−Xe^{-rT}N(d₂)
such that: “C” represents the theoretical value of the call option; “S” represents the price of the underlying stock; “X” represents the option strike price; “r” represents the risk-free interest rate; “T” represents the current time until expiration; “N” represents the area under the normal curve; “d₁” represents [ln(S/X)+(r+σ²/2)T]/σT^{1/2}; and “d₂” represents [d₁−σT^{1/2}].

Since put-call parity requires that:
P=C−S+Xe^{-rT}
when determining the theoretical value of a put option using the Black-Scholes model, the following formula is used:
P=Xe^{-rT}N(−d₂)−SN(−d₁)

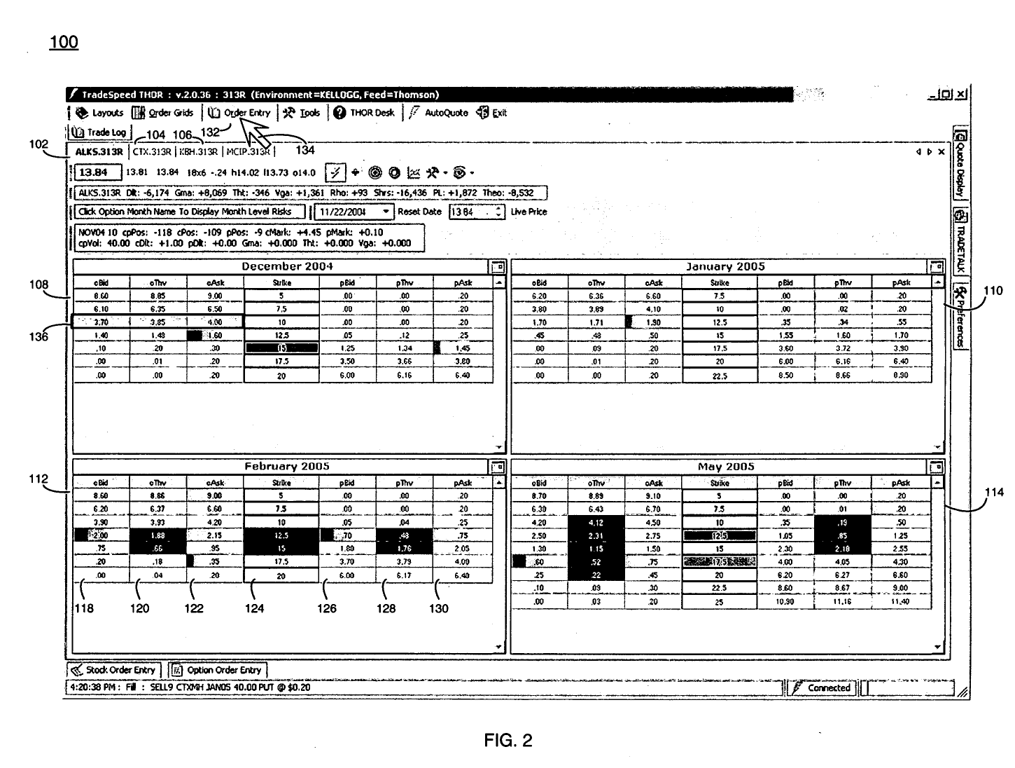

Referring also to FIG. 2, there is shown an option management display screen 100 rendered by option management system 10, which may be displayed for the trader (e.g., trader 12) or the manager (e.g., manager 18) that is using the system (hereinafter “the user”).

Within display screen 100, options may be grouped by security and then may be subdivided into one or more chronological windows. For example, display screen 100 shows available options for Alkermes Inc (Symbol: ALKS). Users of system 10 may configure a tab for each security they are interested in, such as: the Alkermes tab 102; the Centex Corp tab 104; and the KB Home tab 106. When configuring system 10, a user may add/remove tabs (each of which is assigned to a specific security), via e.g., drop down/popup menus (not shown), to expand or reduce the number of securities monitored.

When a tab is selected, the unexercised options (concerning the related security) may be displayed in one or more chronologically-defined windows. For example, the unexercised Alkermes options may be grouped into four windows, namely: a December 2004 window 108; a January 2005 windows 110; a February 2005 windows 112; and a May 2005 windows 114, such that each window may be populated with options that expire within the chronological period defined for the window. For example, the December 2004 window 108 may be populated with unexercised options that will expire in December of 2004.

While display screen 100 is shown to include four windows, this is for illustrative purposes only, as other configurations are possible. For example, the actual number of windows may be increased or decreased, via e.g., drop down/popup menus (not shown), based on the particular tastes of the user or administrator. Further, in the event that the number of windows chosen to be displayed exceeds the maximum number of windows simultaneously displayable within display screen 100, a scroll bar (not shown) may be included within display screen 100 that would allow the user to e.g., scroll downward to view the windows that are not currently displayed.

Additionally, while display screen 100 is shown to include four windows, each of which is associated with a one-month chronological period, other configurations are possible. For example, windows may be configured to span multiple months. Further, windows may be configured to overlap, in which e.g., one window displays the options that will expire during the period from July-September 2004, while a second window displays the options that will expire during the period from August-December 2004.

Each of the chronologically-defined windows (e.g., window 112) included in display screen 100 may be tabular and define (for each item included within the window) various pieces of information, such as: a call bid price 118 (i.e., the highest price any buyer is willing to pay for a call option at a defined strike price at a given time); a call theoretical value 120 (i.e., the calculated value of a call option at a defined strike price at a given time); a call ask price 122 (i.e., the lowest price that any seller is willing to accept for a call option at a defined strike price at a given time); a strike price 124 (i.e., the specified price at which an option contract may be exercised); a put bid price 126 (i.e., the highest price any buyer is willing to pay for a put option at a defined strike price at a given time); a put theoretical value 128 (i.e., the calculated value of a put option at a defined strike price at a given time); and a put ask price 130 (i.e., the lowest price that any seller is willing to accept for a put option at a defined strike price at a given time).

As discussed above, option management system 10 may use e.g., the Black-Scholes model to determine the call theoretical value 120 of the call options (for a given strike price at a given time) and the put theoretical value 128 of the put options (for a given strike price at a given time), which are based upon e.g., the price of the underlying stock, the option strike price, the risk-free interest rate, the current time until expiration, and the area under the normal curve, for example.

When calculating the theoretical value of call options and put options, an initial call option value and an initial put option value may be established for each strike price. For example, referring to the May 2005 window 114, options concerning shares of Alkermes may range in strike price from $5.00 to $25.00, in $2.50 increments. And each strike price may have a respective call bid price, call ask price, put bid price, and put ask price. For example, for a strike price of $12.50, an option to buy (i.e., a call option) one share of Alkermes has a call bid price of $2.50 and a call ask price of $2.75.

When using the valuation algorithm to calculate a theoretical call option value for a particular strike price, the initial call option value may be established as the midpoint between the call bid price and the call ask price. Further, the initial put option value may be established as the midpoint between the put bid price and the put ask price. Therefore, for a strike price of $12.50, an initial call option value of $2.62⁵ may be defined (i.e., the midpoint between the $2.50 call bid price and the $2.75 call ask price) and an initial put option value of $1.15 may be defined (i.e., the midpoint between the $1.05 put bid price and the $1.25 put ask price).

Once these initial values are established, option management system 10 may use a valuation algorithm (e.g., the Black-Scholes model) to calculate a volatility (i.e., “σ”) for each call option (with respect to a strike price at a given time) and for each put option (with respect to a strike price at a given time).

Accordingly, for each strike price, option management system 10 may calculate the call option volatility by inserting the initial call option value into the valuation algorithm and determining the call volatility (i.e., “σ”). Further, option management system 10 may calculate the put option volatility by inserting the initial put option value into the valuation algorithm and determining the put option volatility (i.e., “σ”). This, in turn, may result in a pair of volatilities (i.e., one call option volatility and one put option volatility) for each strike price.

Option management system 10 may use this pair of volatilities to calculate a single “blended” volatility for each strike price. This “blended” volatility may be calculated in various ways. For example, depending on how administrator 36 configures option management system 10, the “blended volatility” may be calculated as follows:
blended volatility=(call volatility+put volatility)/2

Alternatively and as is known in the art, the blended volatility may be calculated in a manner that takes into consideration other factors such strike price and trading price. For example, call options having a strike price that is less than the current value at which a security is trading may be valued greater than call options having a strike price greater than the current value at which a security is trading. Conversely, put options having a strike price greater than the current value at which a security is trading may be valued greater than put options having a strike price less than the current value at which a security is trading.

Once option management system 10 calculates a “blended” volatility for each strike price, the “blended” volatility may be paired with its corresponding strike price to define one x-y data point (i.e., the x-axis coordinate being the strike price, and the y-axis coordinate being the “blended” volatility) for each strike price. This, in turn, may result in a series of data points for plotting on a two-dimensional Cartesian plane. For example, for the May 2005 window 114, nine data points are established (i.e., one for each of the nine strike prices).

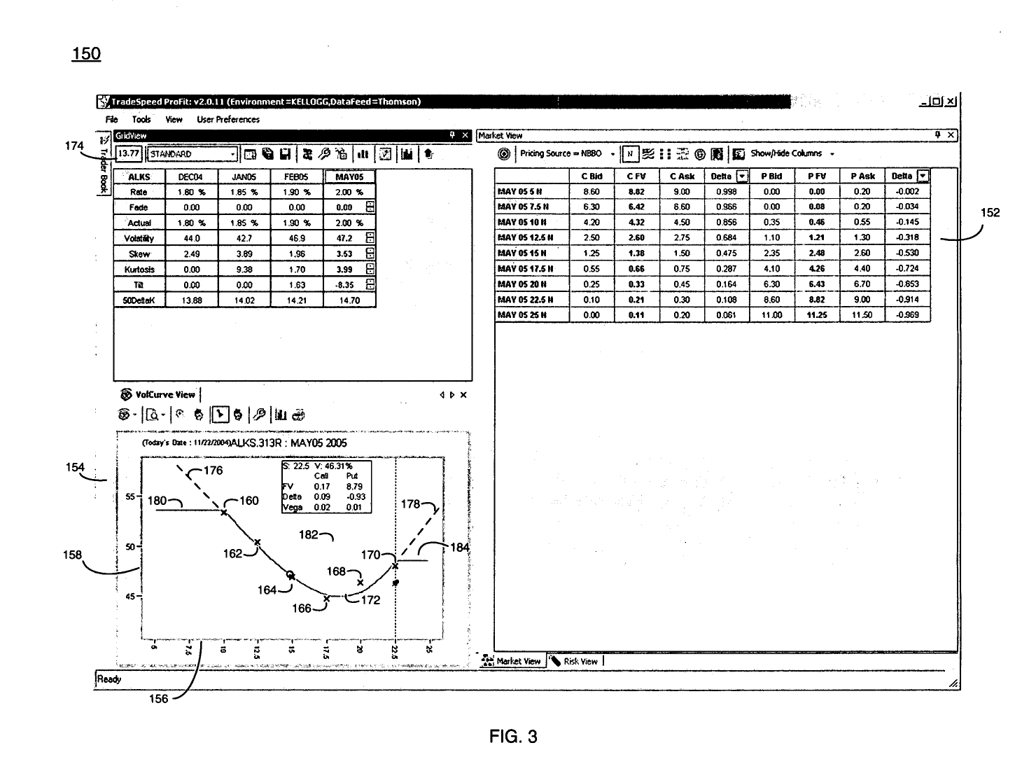

Using option management system 10, the user (e.g., trader 12 or manager 18) may graph this series of data points. Referring also to FIG. 3, there is shown a graph display screen 150 rendered by option management system 10. Data table 152 and volatility curve 154 may be rendered within graph display screen 150. Data table 152 (included within graph display screen 150) may display the same data as the chronologically-defined window being analyzed by the user (which in this example is the May 2005 window 114 of FIG. 2). While there are subtle differences between the data values shown in window 114 and table 152 (e.g., slight changes in bid/ask prices), this is intended to illustrate the fluid nature of the data and the manner in which the data changes during the course of a trading day.

Volatility curve 154 may be generated using the series of data points included within data table 152/window 114. The x-axis 156 of volatility curve 154 may reference strike price and the y-axis 158 of volatility curve 154 may reference volatility. While data table 152 is shown to cover nine strike prices that range from $5.00 to $25.00, only six data points (namely market-derived data points 160, 162, 164, 166, 168, 170) are included within volatility curve 154, as three of the strike prices resulted in calculated “blended” volatilities that exceeded the upper range of y-axis 158 (i.e., a volatility greater than sixty). As discussed above, these market-derived data points may be calculated based upon the initial call option value and initial put option value discussed above.

A curve fitting algorithm (e.g., a least-squares algorithm, a weighted least-squares algorithm, a robust least-squares algorithm, or a non-linear least-squares algorithm, for example) may then be used to plot a best-fit curve 172 through these data points.

For example, the following least-squares algorithm:

$$\begin{matrix}\prod = {\sum }_{i = 1}^{n} {[ {y}_{i} - f ( {x}_{i} ) ]}^{2} \\ = {\sum }_{i = 1}^{n} {[ {y}_{i} - ( {a}_{0} + {a}_{1} {x}_{i} + {a}_{2} {x}_{i}^{2} + … + {a}_{m} {x}_{i}^{m} ) ]}^{2} \\ = min .\end{matrix}$$

may be used to approximate a set of market-derived data points (e.g., (x₁, y₂), (x₂, y₂), . . . . . . (xₙ, yₙ); wherein n≦m+1), such that the resulting best-fit curve has the least squares error.

The curve fitting algorithm may be a third or fourth order polynomial. However, the order of the polynomial may be reduced when generating a best-fit curve for a reduced number of data points.

Certain market-derived data points (within the series of data points) may be considered more trustworthy than others and are weighted more heavily (within the curve-fitting algorithm). For example, market-derived data points having a strike price closer to the actual trading price of a security may be weighted more heavily (i.e., deemed more trustworthy) than market-derived data points having a strike price that is comparatively far away from the actual trading price of the security. Accordingly, since shares of Alkermes are trading for $13.77 (see trading price indicator 174), best-fit curve 172 may more closely track the heavily-weighted market-derived data points (e.g., data point 162, 164, 166) than the lightly-weighted market-derived data points (e.g., data points 160, 168, 170).

Typically, the market-derived data points (e.g., data points 160, 162, 164, 166, 168, 170) form a parabolic curve (shown with phantom line segments 176, 178), such that the left-most and right-most portions of the curve approach infinity.

Best-fit curve 172 may include three portions, a left-wing portion 180, a center portion 182, and a right-wing portion 184. Center portion 182 often closely approximates the parabolic curve formed by the market-derived data points (e.g., data points 160, 162, 164, 166, 168, 170), and the left-wing and right-wing portions 180, 184 may be essentially linear horizontal line segments. The left-wing and right-wing portions 180, 184 may be smoothly joined to the center portion 182 using a standard spline smooth algorithm.

The following formula is an example of a spline smoothing algorithm:

$$p {\sum }_{i} {{w}_{i} ( {y}_{i} - s ( {x}_{i} ) )}^{2} + ( 1 - p ) \int {( \frac{{ⅆ}^{2} s}{ⅆ {x}^{2}} )}^{2} ⅆ x$$

wherein 0≦p≦1, and p=0 produces a least squares straight line fit between data points; and p=1 produces a cubic spline interpolant between data points.

When defining the left-wing and right-wing portions 180, 184 of best-fit curve 172, option management system 10 may define the strike price transition point between left-wing portion 180 and center portion 182 as the strike price having the lowest non-zero call bid price (i.e., strike price $22.50 which has a call bid price of $0.10). Further, option management system 10 may define the transition between center portion 182 and right-wing portion 184 as the strike price having the lowest non-zero put bid price (i.e., strike price $10.00 which has a call bid price of $0.35).

However, transition points may be defined using other methodologies. For example, option management system 10 may define the strike price transition point between left-wing portion 180 and center portion 182 as the strike price having the first (or second) $0.00 call bid price. Further, option management system 10 may define the transition point between center portion 182 and right-wing portion 184 as the strike price having the first (or second) $0.00 put bid price. As discussed above, at the transition points, the left-wing and right-wing portions 180, 184 may be smoothly joined to the center portion 182 of best-fit curve 172 using a standard spline smoothing algorithm.

Once the two transition points are defined, all volatilities at strike prices greater than the “center portion to right wing portion” transition point (i.e., strike prices greater than $22.50) may be set equal to the volatility of the “center portion to right-wing portion” transition point. Further, all volatilities at strike prices less than the “center portion to left-wing portion” transition point (i.e., strike prices less than $10.00) may be set equal to the volatility of the “center portion to left-wing portion” transition point.

Once best-fit curve 172 is defined, option management system 10 may populate data table 152 (and, in this example, window 114) with a theoretical call value and a theoretical put value for each strike price. For example, the theoretical call value for a strike price of $12.50 is $2.60 (i.e., slightly less than the initial call value of $2.62⁵), and the theoretical put value for a strike price of $12.50 is $1.21 (i.e., greater than the initial put value of $1.15).

When calculating the theoretical call values and the theoretical put values for each strike price, option management system 10 may determine (using best-fit curve 172) the volatility (i.e., “σ”) for each strike price. For example, the volatility associated with a strike price of $5.00 is approximately 53.5 and the volatility associated with a strike price of $15.00 is approximately 46.5. Accordingly, once a volatility is associated with each strike price, option management system 10 may calculate the theoretical call values and the theoretical put values using a valuation algorithm discussed above (e.g., the Black-Scholes model or the Cox-Rubenstein model, for example).

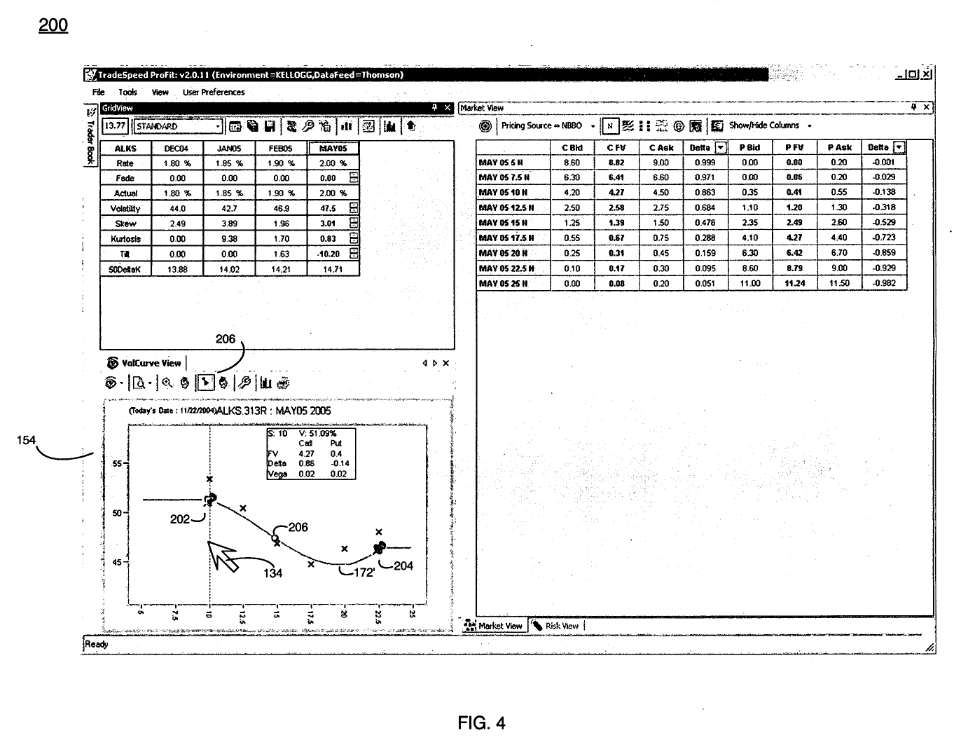

Using option management system 10, users may tailor best-fit curve 172 so that the curve more closely adheres to their personal tastes and preferences (e.g., aversion to risk, and personal knowledge, for example). Referring also to FIGS. 4 & 5, there is shown a modified graph display screen 200 that includes two adjustment pin-points 202, 204 positioned (by the user of system 10) to reconfigure best-fit curve 172.

Accordingly, option management system 10 may process 220 a plurality of initial data points, such that each initial data point includes a strike price coordinate and a volatility coordinate. A best-fit curve (e.g., best-fit curve 172) may be generated 222 based, at least in part, upon two or more of the plurality of initial data points, such that the best-fit curve may define a plurality of best-fit data points. Each best-fit data point may include a strike price coordinate and a volatility coordinate. A user may be allowed 224 to graphically modify one or more of the best-fit data points (using e.g., adjustment pin-points 202, 204) to define one or more modified best-fit data points.

Allowing 224 a user to graphically modify one or more of the best-fit data points may include allowing 226 the user to graphically modify the volatility coordinate (e.g., by dragging the adjustment pin-point up or down) and/or allowing 228 the user to graphically modify the strike price coordinate (e.g., by dragging the adjustment pin-point left or right) of one or more of the best-fit data points.

As discussed above, the volatility coordinate of at least one of the initial data points and/or the best-fit data points may include a blended volatility coordinate. Generating 222 a best-fit curve may include defining 230 the plurality of best-fit data points with a curve fitting algorithm (e.g., a least-squares algorithm, a weighted least-squares algorithm, a robust least-squares algorithm, and/or a non-linear least-squares algorithm). A weight may be assigned 232 to at least one of the modified best-fit data points that is greater than a weight assigned to a corresponding best-fit data point. One or more of a theoretical call value and a theoretical put value may be calculated 234 based, at least in part, upon one or more of the modified best-fit data points.

Continuing with the above-stated example, assume that the user of system 10 considers a volatility of 53.50 to be too high for a strike price of $10.00, and thinks that the volatility should actually be 51.00. Accordingly, system 10 may allow the user of option management system 10 to graphically position (via screen pointer 134, which is controllable by a pointing device, not shown) adjustment pin-point 202 within volatility curve 154 and define a volatility of 51.00 for a strike price of $10.00. This, in turn, defines a first modified best-fit data point (i.e., $10.00, 51.00). Further, assume that the user of system 10 considers a volatility of 49.00 to be too high for a strike price of $22.50, and thinks the volatility should actually be 46.00. Accordingly, system 10 may allow the user of option management system 10 to graphically position (via screen pointer 134) adjustment pin-point 204 within volatility curve 154 and define a volatility of 46.00 for a strike price of $22.50. This, in turn, defines a second modified best-fit data point (i.e., $22.50, 46.00).

While system 10 is described above as including two adjustment pin-points, other configurations are possible, as the number of adjustment pin-points may be increased or decreased in accordance with the needs/tastes of the user. To add additional adjustment pin-points, the user may select (via e.g., screen pointer 134) the “add a pin-point” button 206. Additionally, while the adjustment pin-points are described above as lowering volatilities, this is for illustrative purposes only, as adjustment pin-points may also be used to raise volatilities.

As discussed above, the various market-driven data points may be weighted in accordance with their proximity to the actual trading value of the security in question. Concerning adjustment pin-points 202, 204, option management system 10 may assign 232 weights to these points that are orders of magnitude greater than the market-driven data points (i.e., data points 160, 162, 164, 166, 168, 170) that were derived from market data (i.e., call bid prices, call ask prices, put bid prices, and put ask prices). For example, if weights within the range of 1-10 are applied to the market-derived data points, a weight of e.g., 100,000 may be applied to adjustment pin-points 202, 204. This enormous disparity between the market-derived data points (i.e., data points 160, 162, 164, 166, 168, 170) and adjustment pin-points 202, 204 may mandate that best-fit curve 172 pass through adjustment pin-points 202, 204. When adjusting best-fit curve 172 through the use of adjustment pin-points 202, 204, the above-described curve fitting algorithm may be re-executed to compensate for adjustment pin-points 202, 204, such that the weighting coefficients within the curve fitting algorithm may be adjusted to reflect the comparatively enormous weight assigned to adjustment pin-points 202, 204.

Since adjustment pin-points 202, 204 are actually the transition points (i.e., between left-wing portion 180/center portion 182 and center portion 182/right-wing portion 184 respectively), by reducing the volatilities at these points, the volatilities of the left-wing portion and the right-wing portion may also reduced.

As discussed above, the generation of a best-fit curve may result in the calculation of the theoretical call values and the theoretical put values for each strike price. Accordingly, the generation of a modified best-fit curve 172′ (i.e., best-fit curve 172 modified by adjustment pin-points 202, 204) may result in the recalculation of the theoretical call values and the theoretical put values for each strike price. As discussed above, when recalculating the theoretical call values and the theoretical put values for each strike price, option management system 10 may determine (from modified best-fit curve 172′) the volatility (i.e., “σ”) for each strike price. For example, the volatility associated with a strike price of $5.00 is now 51.00 and the volatility associated with a strike price of $25.00 is now 46.00. Accordingly, once a volatility is associated with each strike price, option management system 10 may recalculate the theoretical call values and the theoretical put values using the valuation algorithm discussed above (e.g., the Black-Scholes model or the Cox-Rubenstein model).

As described above and referring again to FIG. 3, best-fit curve 172 may be generated by option management system 10 in response to market data (i.e., call bid prices, call ask prices, put bid prices, and put ask prices). Accordingly, since this generation of best-fit curve 172 is automated and does not require user input, option management system 10 may allow the user to define a “batch-process” in which all options (or portions thereof) for all securities (or portions thereof) are processed as a group.

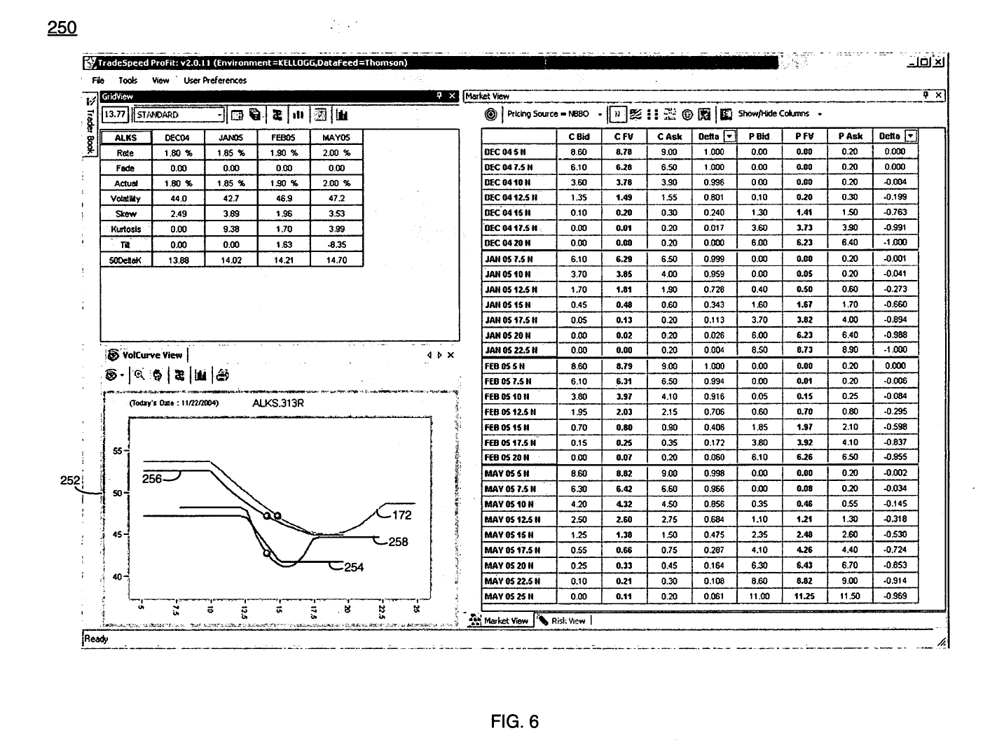

Accordingly and referring also to FIGS. 6 & 7, when batch processing a plurality of option sets (e.g., as represented by windows 108, 110, 112, 114 of FIG. 2), option management system 10 may process 280, for each of the plurality of option sets, a group of initial data points, such that each initial data point includes a strike price coordinate and a volatility coordinate. On a single Cartesian plane (e.g., volatility curve 252), a best-fit curve may be generated 282 for each of the plurality of option sets. Each best-fit curve may be based, at least in part, upon two or more of the initial data points included within the respective group. Each best-fit curve may define a plurality of best-fit data points, and each best-fit data point may includes a strike price coordinate and a volatility coordinate.

The volatility coordinate of at least one of the initial data points and/or the best-fit data points may include a blended volatility coordinate.

Generating 282, on a single Cartesian plane and for each of the plurality of option sets, a best-fit curve may include defining 284, for each of the plurality of option sets, the plurality of best-fit data points with a curve fitting algorithm. The curve fitting algorithm may include one or more of: a least-squares algorithm; a weighted least-squares algorithm; a robust least-squares algorithm; and a non-linear least-squares algorithm.

As discussed above, a user may be allowed 286 to graphically modify one or more of the best-fit data points (e.g., using the adjustment pin-points described above) to define one or more modified best-fit data points. Allowing 286 a user to graphically modify one or more of the best-fit data points may include: allowing 288 the user to graphically modify the volatility coordinate (e.g., by dragging the adjustment pin-point up or down) and/or allowing 290 the user to graphically modify the strike price coordinate (e.g., by dragging the adjustment pin-point left or right)

As discussed above, a weight may be assigned 292 to at least one of the modified best-fit data points that is greater than a weight assigned to a corresponding best-fit data point. One or more of a theoretical call value and a theoretical put value may be calculated 294 based, at least in part, upon one or more of the modified best-fit data points. The user may be allowed 296 to define the plurality of option sets (each of which may define a unique chronological period) to be included in the above-described batch process. The user may select which options sets (e.g., which of windows 108, 110, 112, 114 of FIG. 2) to include in the above-described batch process via one or more drop down/popup menus (not shown).

Continuing with the above-stated example, a best-fit curve 172 was defined for the data displayed in the May 2005 window 114 (i.e., a first option set). However, as discussed above, display screen 100 also includes a December 2004 window 108 (i.e., a second option set), a January 2005 windows 110 (i.e., a third option set), and a February 2005 windows 112 (i.e., a fourth option set). As discussed above, option management system 10 may allow for the batch processing of the data in all four windows (i.e., windows 108, 110, 112, 114) and the generation of multi-curve graph display screen 250. Multi-curve graph display screen 250 may include a volatility curve 252 that includes a best-fit curve for each option set (i.e., the data specified in each of windows 108, 110, 112, 114). Accordingly, in addition to best-fit curve 172 which corresponds to the data of the May 2005 window 114, best-fit curve 254 corresponds to the data of the December 2004 window 108, best-fit curve 256 corresponds to the data of the February 2005 window 112, and best-fit curve 258 corresponds to the data of the January 2005 window 110.

As described above and referring again to FIG. 4, users of option management system 10 may modify best-fit curve 172 so that the best-fit curve more closely adheres to their personal tastes and preferences (e.g., aversion to risk, and personal knowledge, for example). Due to the fluid nature of the market, modifications made to best-fit curve 172 may only have a duration of one trading day, in that restarting option management system 10 on a subsequent day may result in the calculation of a new best-fit curve that uses the subsequent-day's market data (i.e., call bid prices, call ask prices, put bid prices, and put ask prices). However, for securities that exhibit a high-level of trading price stability, it may be desirable to apply the techniques used to modify e.g., best-fit curve 172 to the best-fit curves generated for the same option on one or more subsequent trading days. Naturally, the practicality and viability of repeatedly applying the same modification to multiple subsequent trading days may quickly diminish as the time period is extended to greater than e.g., one trading week.

Accordingly, option management system 10 allows a user to modify multiple best-fit curves (each of which was generated based on the market data for consecutive trading days of the same option), based on the modification(s) made to the earliest best-fit curve.

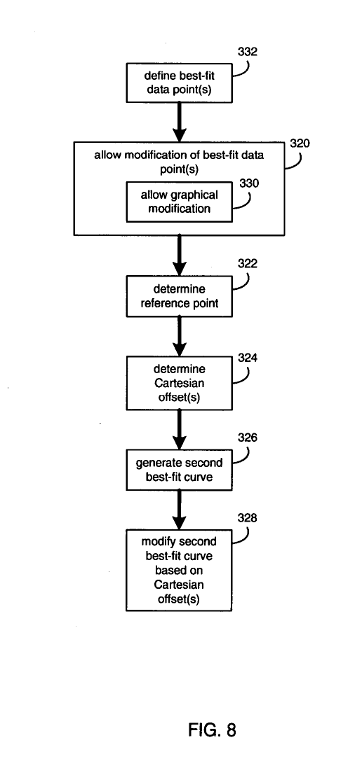

Accordingly and referring also to FIG. 8, when modifying a plurality of best-fit curves, option management system 10 may allow 320 a user to modify one or more best-fit data points included within a first best-fit curve to define one or more modified best-fit data points. As discussed above, the first best-fit curve may define a volatility of an option, with respect to a strike price, for a first chronological period (i.e., a first trading day). A reference point (e.g., a 50Δ point, to be discussed below in greater detail) may be determined 322 along the first best-fit curve. A Cartesian offset (to be discussed below in greater detail), with respect to the reference point, may be determined 324 for each of the modified best-fit data points.

A second best-fit curve may be generated 326 that defines the volatility of the option, with respect to the strike price, for a second chronological period (e.g., a second trading day). The second best-fit curve may include one or more best-fit data points. At least one best-fit data point included within the second best-fit curve may be modified 328, based upon the Cartesian offset, to define at least one modified best-fit data point.

Allowing 320 a user to modify one or more best-fit data points may include allowing 330 the user to graphically modify one or more best-fit data points (as discussed above) included within the first best-fit curve to define the one or more modified best-fit data points. The one or more best-fit data points included within the first best-fit curve may be defined 332 using a curve fitting algorithm (e.g., a least-squares algorithm; a weighted least-squares algorithm; a robust least-squares algorithm; and a non-linear least-squares algorithm).

Continuing with the above-stated invention, assume that when the user of option management system 10 modified best-fit curve 172, that modification was made on Monday, 22 Nov. 2004. If shares of Alkermes change value comparatively slowly, it may be desirable to reapply that modification (made to best-fit curve 172) to the best-fit curve generated on Tuesday, 23 Nov. 2004. Accordingly, when modifying a best-fit curve, option management system 10 may determine a reference point (e.g., 50Δ point 206), which represents the point at which the option has a 50% chance of ending up “in the money” (i.e., an option with intrinsic value and one which would therefore be profitable for the holder to exercise, such as a call option whose strike price is below the current price of the security, or a put option whose strike price is above the current price of the security). In this particular example, the 50Δ point 206 represents a strike price of $14.75 and a volatility of 47.50.

As discussed above, “d₁” is equal to [ In(S/X)+(r+σ²/2)T]/σT^{1/2}. For calls, Δ is equal to N(d₁). For puts, Δ is equal to N(d₁)−1. As discussed above, “N” represents the area under the normal curve. Accordingly, by setting delta equal to 0.50 and solving for “X” (i.e., the option strike price), 50Δ point 206 may be determined. As is known in the art, 50Δ point 206 is typically solved iteratively using partial derivatives and a valuation algorithm discussed above (e.g., the Black-Scholes model or the Cox-Rubenstein model).

As discussed above, option management system 10 may use 50Δ point 206 as a means for defining the modifications made to best-fit curve 172 by the user. For example and as discussed above, the user of option management system 10 defined two adjustment pin-points 202, 204 that modified best-fit curve 172 (i.e., to define modified best-fit curve 172′). The coordinates of adjustment pin-point 202 are ($10.00, 51.00) and the coordinates of adjustment push-pin 204 are ($22.50, 46.00); and the coordinates of 50Δ point 206 are ($14.75, 47.50).

Accordingly, option management system 10 may define: a Cartesian offset (i.e., the absolute modification associated with adjustment pin-point 202) with respect to 50Δ point 206 to be (−$4.75, +3.50); and may define a Cartesian offset (i.e., the absolute modification associated with adjustment pin-point 204) with respect to 50Δ point 206 to be (+$7.75, −1.50). Accordingly, if the user chooses to apply this set of modifications (i.e., the modifications that converted best-fit curve 172 into modified best-fit curve 172′) to the best-fit curve generated for a subsequent trading day of the same security, option management system 10 may first determines the 50Δ point for the market data of the subsequent trading day. Once this 50Δ point is determined for the subsequent trading day, option management system 10 may apply the absolute modifications (i.e., Cartesian offset(s)) to the best-fit curve of the subsequent trading day.

For example, assume that the 50Δ point for the subsequent trading day is ($14.25, 49.50), which is slightly changed from the 50Δ point of the previous day (i.e., ($14.75, 47.50)). Accordingly, option management system 10 may define two adjustment pin-points for modifying the subsequent day's best-fit curve, namely: ($14.25−$4.75, 49.50+3.50) which is ($9.50, 53.00); and ($14.25+$7.75, 49.50−1.50) which is ($22,00, 48.00). As discussed above, the user of system 10 may choose to apply similar modifications to multiple subsequent trading days. However, the practicality and viability of repeatedly applying the same modification to multiple subsequent trading days may quickly diminish as the time period is extended.

In addition to the valuation functionality described above, option management system 10 may allow a user to purchase options. For example and referring again to FIG. 2, by selecting order entry button 132 (via a screen pointer 134 that is controllable by a pointing device such as a computer mouse, not shown), the user may be allowed to enter an order for a selected option (e.g., call option 136 that is exercisable in December of 2004 and has a strike price of $10.00, a call bid price of $3.70 (per share), a call ask price of $4.00 (per share), and a theoretical call value of $3.85 (per share). While the option price is listed as price per option, options may be sold in round lots (i.e., units of one hundred options).

Since the cost of an option is determined by the rules of supply and demand, the prices associated with options are fluid. Accordingly, as the number of options available for purchase increases, the bid price and ask price for those options typically decreases. Conversely, as the number of options available for purchase decreases, the bid price and ask price for those options typically increases. Accordingly, when a purchaser purchases a sizable quantity of options, the price the purchaser will need to pay for the options purchased may increase as the options are purchased (i.e., the purchaser may pay less for the first round lot of options and more for the last round lot of options). And conversely, if a seller sells a sizable quantity of options, the price that the seller will receive for the options sold may decrease as the options are sold (i.e., the seller may receive more for the first round lot sold and less for the last round lot sold).

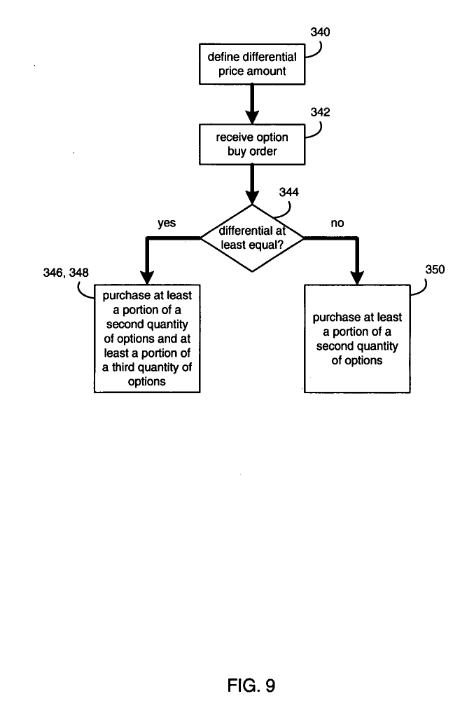

Accordingly and referring also to FIG. 9, option management system 10 may define 340 a differential price amount, such as a defined amount of currency (e.g., $10.00) or a percentage of a bid/ask price (e.g., 5.00%). An option buy order may be received 342 by option management system 10 for a first quantity of options at a first price, thus defining the user's intention to buy a first quantity of options at a first price. A second quantity of options, which is less than the first quantity of options, may be available for purchase at the first price and a third quantity of options may be available for purchase at a second price, which is greater than the first price.

The differential price amount may be compared 344 to the difference between the second and first prices. If the differential price amount is at least equal to the difference between the second and first prices, at least a portion of the second quantity of options may be purchased 346 at the first price and at least a portion of the third quantity of options may be purchased 348 at the second price. If the differential price amount is less than the difference between the second and first prices, at least a portion of the second quantity of options may be purchased 350 at the first price. However, no options will be purchased at the second price

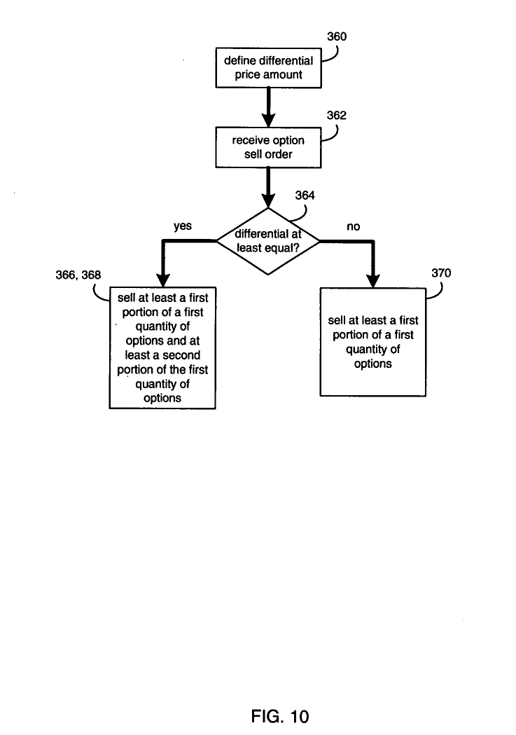

Further and referring also to FIG. 10, option management system 10 may define 360 a differential price amount (as discussed above). An option sell order may be received 362 for a first quantity of options at a first price, thus defining the user's intention to sell a first quantity of options at a first price. A second quantity of options, which is less than the first quantity of options, may be sought for purchase at the first price. A third quantity of options may be sought for purchase at a second price, which is less than the first price.

The differential price amount may be compared 364 to the difference between the first and second prices. If the differential price amount is at least equal to the difference between the first and second prices, at least a first portion of the first quantity of options may be sold 366 at the first price and at least a second portion of the first quantity of options may be sold 368 at the second price. If the differential price amount is less than the difference between the first and second prices, at least a first portion of the first quantity of options may be sold 370 at the first price. However, no options will be sold at the second price

Accordingly, option management system 10 may allow a user to define a differential price amount concerning the purchase or sale of options. Continuing with the above-stated example in which the user selects option 136 (FIG. 2) for purchase, assume that the user wishes to purchase 100,000 options and is willing to pay the going asking price of $4.00 per option (i.e., for a total purchase of $400,000). As discussed above, this large option purchase of this particular option may drive the asking price for this particular option up. For example, the user may only be able to purchase 50,000 options at $4.00 per option prior to the asking price rising to $4.05 per option. The user may then be able to purchase another 30,000 options at $4.05 per option, with the remaining 20,000 options purchased for $4.10 per option. Assuming that the user only specified a static bid price of $4.00 per option, only 50% of the user's 100,000 option purchase order would be filled, as only 50,000 options are available at $4.00 per option.

Accordingly, option management system 10 allows the user to define 340 a differential price amount (e.g., $0.15) that represents the amount that the user is willing to exceed their base bid in order to fulfill their order. For example, if the user defined a differential price amount of $0.00, only 50,000 options would be purchased. However, if the user defined a differential price amount of $0.05, 80,000 options would be purchased. Further if the user defined a differential price amount of $0.10 or above, the complete 100,000 option order would be fulfilled.

Accordingly, option management system 10 may compare 344 the differential price amount (e.g., $0.15) to the price difference (e.g., $4.05−$4.00). As the differential price amount (e.g., $0.15) at least exceeds the difference (e.g., $0.05), option management system 10 may effectuate the purchase of 50,000 options at $4.00 per option and 30,000 options at $4.05 per option. As the option order would not be fulfilled with 80,000 options, option management system 10 may compare the differential price amount (e.g., $0.15) to the greater price difference (e.g., $4.10−$4.00), which represents the difference between the user's base bid (e.g., $4.00 per option) and the highest per option amount required to fulfill the complete order (e.g., $4.10 per option). As the differential price amount (e.g., $0.15) at least exceeds the difference (e.g., $0.10), option management system 10 may effectuate the purchase of 50,000 options at $4.00 per option, 30,000 options at $4.05 per option, and 20,000 options at $4.10 per option.

While the differential price amount is described above as the amount that a person buying a quantity of options is willing to exceed their base bid in order to fulfill the complete option purchase, the differential amount (when selling options) is defined as the amount that a seller is willing to reduce their asking price in order to fulfill an option sale.

For example, assume that the user wishes to sell 100,000 options at $4.00 per option (i.e., for a total sale of $400,000). As discussed above, this large sale of this particular option may drive the selling price for this particular option down. For example, the user may only be able to sell 50,000 options at $4.00 per option prior to the selling price dropping to $3.95 per option. The user may then be able to sell another 30,000 options at $3.95 per option, with the remaining 20,000 options being sold for $3.90 per option.

Again, assuming that the user only specified a static asking price of $4.00 per option, only 50% of the user's 100,000 options would be sold, as only 50,000 options are sought at $4.00 per option.

Accordingly, option management system 10 may allow the user to define 360 a differential price amount (e.g., $0.15) that represents the amount that the user is willing to reduce their asking price in order to fulfill the sale. For example, if the user defined a differential price amount of $0.00, only 50,000 options would be sold. However, if the user defined a differential price amount of $0.05, 80,000 options would be sold. Further, if the user defined a differential price amount of $0.10 or above, all 100,000 options would be sold.

As the market is fluid and constantly changing, an option purchase price may be minimized (or an option sale price maximized) by delaying the respective option purchase or option sale. For example, if the option market is trending downward and the user is interested in purchasing options, delaying the purchase of the options may result in a reduced purchase price. Conversely, if the option market is trending upward and the user is interested in selling options, delaying the sale of the options may result in an increased sale price.

Accordingly, option management system 10 may allow a user to define an order execution delay period for fulfilling an option purchase or option sale. A typical value of such an order execution delay period is six seconds. Therefore, once the order execution delay period of option management system 10 is enabled by the user, whenever a user enters a purchase order for an option, option management system 10 may examine the market to determine if the value of the option sought for purchase is trending downward. In the event that the option value is trending downward, option management system 10 may delay the option purchase for the order execution delay period on the premise that the option value may decrease. However, if when initially checked (or during the course of the order execution delay period), the value of the option sought for purchase is trending upward, option management system 10 may execute the option purchase.

Further, if the order execution delay period of option management system 10 is enabled by the user, whenever a user enters a sale order for an option, option management system 10 may examine the market to determine if the value of the option offered for sale is trending upward. In the event that the option value is trending upward, option management system 10 may delay the option sale for the order execution delay period on the premise that the option value may increase. However, if when initially checked (or during the course of the differential time period), the value of the option offered for sale is trending downward, option management system 10 may execute the option sale.

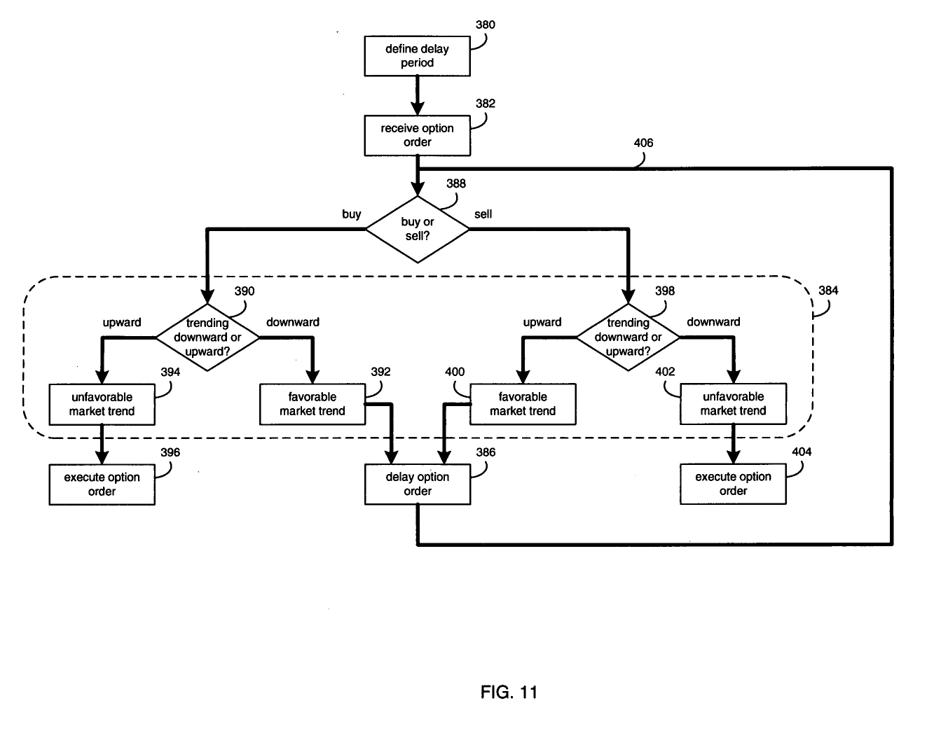

Accordingly and referring also to FIG. 11, option management system 10 may define 380 an order execution delay period (e.g., a period of time), such that the order execution delay period may define a maximum delay between an option order placement time and an option order execution time. An option order may be received 382 for a particular option, which may define the option order placement time (since the time that the option order was placed is known). A market trend for the particular option may be determined 384 and, if a favorable market trend is determined, the option order execution time may be delayed 386 for at least a portion of the order execution delay period.

The option order may be 388 an option buy order. Determining 384 a market trend for the particular option may include determining 390 if one or more of an asking price and a bid price for the particular option is trending downward and, if so, defining 392 the market trend for the particular option as a favorable market trend. Determining 384 a market trend for the particular option may include determining 390 if one or more of an asking price and a bid price for the particular option is trending upward and, if so, defining 394 the market trend for the particular option as an unfavorable market trend. If an unfavorable market trend is determined 394, the option order may be executed 396.

The option order may be 388 an option sell order. Determining 384 a market trend for the particular option may include determining 398 if one or more of an asking price and a bid price for the particular option is trending upward and, if so, defining 400 the market trend for the particular option as a favorable market trend. Determining 384 a market trend for the particular option may include determining 398 if one or more of an asking price and a bid price for the particular option is trending downward and, if so, defining 402 the market trend for the particular option as an unfavorable market trend. If an unfavorable market trend is determined 402, the option order may be executed 404.

If the market trend for the particular option is defined 392, 400 as a favorable market trend, and the option order execution time is delayed 386 for at least a portion of the order execution delay period, an interim market trend for the particular option may be determined (e.g., via loop 406) during a portion of the order execution delay period. If an unfavorable interim market trend is determined 396, 404, the option order may be executed.

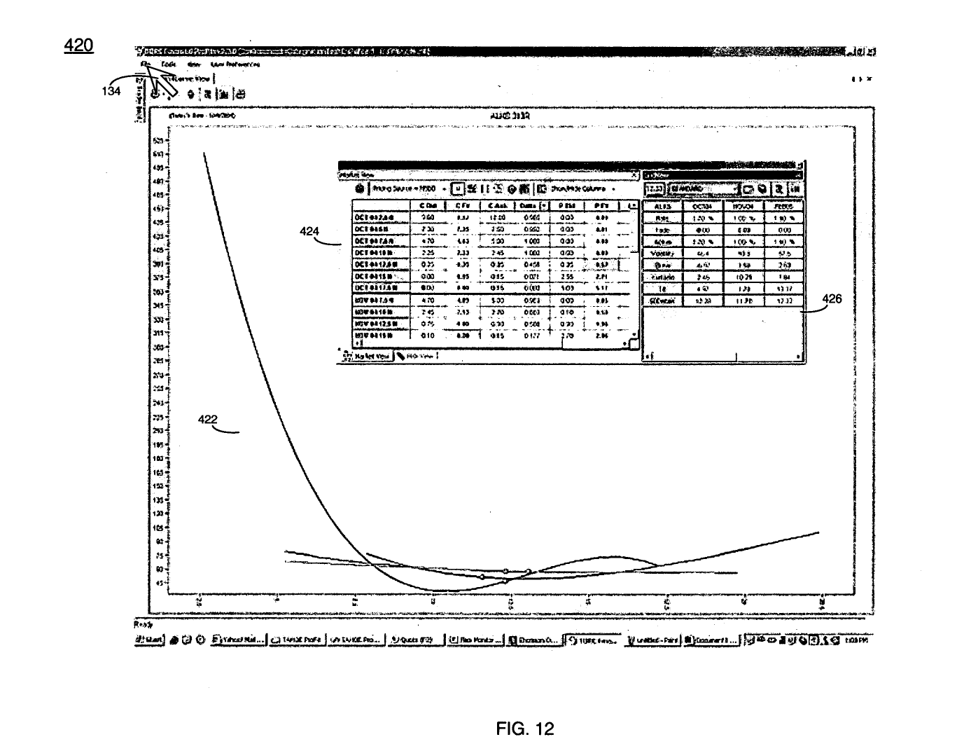

Referring also to FIGS. 12 & 13, option management system 10 may allow a user to dynamically configure a desktop display screen 420 by grouping desktop objects and saving one or more of the unique groupings for later use. Accordingly, when defining a desktop configuration, option management system 10 may position 440 one or more desktop objects (e.g., an icon object, a chart object, a table object, a window object, and a menu object, for example) within a graphical user interface of an option management system 10. A location identifier may be associated 442 with at least one of the one or more desktop objects, such that the location identifier defines the position of the at least one of the one or more desktop objects within the graphical user interface. For example, the location identifier may define (in XY pixel coordinates) the location of the upper left-hand corner of a window object. The location identifier may be stored 444 on a storage device (e.g., storage device 30, FIG. 1) for subsequent retrieval by a user.

Storing 444 the location identifier may include including 446 the location identifier within a location identifier file. Alternatively/additionally, storing 444 the location identifier may include assigning 448 a name to the location identifier file.

The graphical user interface may include a desktop screen and positioning 440 one or more desktop objects within a graphical user interface may include positioning 450 one or more desktop objects within the desktop screen.

A new session of option management system 10 may be initiated 452 (e.g., computer 24 and/or computer 32 may be rebooted), and the previously-stored location identifier may be retrieved 454 from the storage device. Accordingly, one or more desktop objects may be positioned 456 within the graphical user interface in accordance with the location identifier.

Continuing with the above-stated example, desktop display screen 420 may include a data graph 422, a first tabular data window 424, and a second tabular data window 426 (collectively referred to as desktop objects). During use, the user of option management system 10 may position windows 424, 426 above data graph 422 (as shown in FIG. 12) and may then select (via screen pointer 134) the e.g., “File” dropdown menu (not shown) and subsequently select “Save Desktop” (not shown). If option management system 10 is configured to allow the user to save multiple desktops, the user may be prompted to assign a unique name (e.g., Wednesday desktop) to the particular desktop configuration being saved. Once saved, a desktop configuration may be subsequently retrieved and the various windows (e.g., windows 424, 426) included within desktop display screen 420 may be automatically positioned properly within desktop display screen 420.

Option management system 10 may include a risk-management tool that allows administrator 36 or a manager (e.g., manager 18) to define risk violation rules. In the event that a trader using system 10 violates one or more of these rules, automated notifications (e.g., email or voice messages, for example) may be transmitted to intended recipients. For example, the risk management tool of option management system 10 may allow administrator 36 or e.g., manager 18 to define a list of intended recipients to be notified in the event of a violation of a risk rule. Typically, the intended recipient list may vary depending on the individual violating the rule. For example, in the event of a rule violation by a junior trader, the immediate supervisor of the junior trader may be notified; the trader manager may be notified; and the firm manager may be notified. Accordingly, option management system 10 may allow administrator 36/manager 18 to define an intended recipient list that is unique for each potential violator of the risk violation rules. Examples of such risk violation rules include pre-defined measurables, such as: Position Delta; Position Gamma; Position Vega; Position Rho; Position Theta; % Price Change of Underlying on the Day; and Absolute Price Change of Underlying on the Day, for example.

Once the risk violation rules are configured and the intended recipient lists are defined by administrator 36/manager 18, option management system 10 may repeatedly and periodically evaluate (e.g., once every five seconds) the risk violation rules to determine if violations have occurred. In the event of a violation, the automated notification procedure described above is executed.

Once a notification is received by a supervising party (e.g., administrator 36/manager 18), the supervising party may choose to e.g.,: authorize an override of the violation; or take a remedial action in response to the violation. Examples of such remedial actions may include: communicating with the trader (telephonically or via email, for example), issuing a warning to the trader, or shutting down the trader (i.e., disconnecting the trader from option management system 10), for example.

Option management system 10 may include a dedicated communication network (not shown) interoperable with networks 26, 28 for allowing the traders 12, 14, 16, managers 18, 20, 22, and administrator 36 to communicate with each other. The dedicated communication network, which may be a secure communication network (e.g., one that uses SSL TCP/IP connections), may allow the parties (i.e., traders, managers, and administrators) to communicate with each other outside of the trading network used by option management system 10. As the dedicated communication network is a stand-alone network, in the event that the trading network (i.e., the network that allows option management system 10 to execute trades) fails, the dedicated communication network may still function.

While option management system 10 is described above as residing on and being executed by computer 24, other configurations are possible. For example, option management system 10 may (wholly or partially) reside on and may (wholly or partially) be executed by computer 24, which is also connected to network 26. Further, the instruction sets and subroutines of option management system 10, which may be stored on a storage device (not shown) coupled to computer 32, may be executed (wholly or partially) by one or more processors (not shown) and one or more memory architectures (not shown) incorporated into computer 32. The storage device (not shown) coupled to computer 32 may be, for example, a hard disk drive, a tape drive, an optical drive, a RAID array, a random access memory (RAM), or a read-only memory (ROM).

A number of implementations have been described. Nevertheless, it will be understood that various modifications may be made. Accordingly, other implementations are within the scope of the following claims.

What is claimed is:

1. A method of batch processing a plurality of option sets comprising:
processing, for each of the plurality of option sets, a group of initial data points, wherein each initial data point includes a strike price coordinate and a volatility coordinate; and
generating, on a single Cartesian plane and for each of the plurality of option sets, a best-fit curve based, at least in part, upon two or more of the initial data points included within the respective group, wherein each best-fit curve defines a plurality of best-fit data points, and wherein each best-fit data point includes a strike price coordinate and a volatility coordinate.

2. The method of claim 1 wherein the volatility coordinate of at least one of the initial data points includes a blended volatility coordinate.

3. The method of claim 1 wherein the volatility coordinate of at least one of the best-fit data points includes a blended volatility coordinate.

4. The method of claim 1 wherein generating, on a single Cartesian plane and for each of the plurality of option sets, a best-fit curve includes:
defining, for each of the plurality of option sets, the plurality of best-fit data points with a curve fitting algorithm.

5. The method of claim 4 wherein the curve fitting algorithm includes one or more of: a least-squares algorithm; a weighted least-squares algorithm; a robust least-squares algorithm; and a non-linear least-squares algorithm.

6. The method of claim 1 further comprising:
allowing a user to graphically modify one or more of the best-fit data points to define one or more modified best-fit data points.

7. The method of claim 6 wherein allowing a user to graphically modify one or more of the best-fit data points includes:
allowing the user to graphically modify the volatility coordinate of one or more of the best-fit data points.

8. The method of claim 6 wherein allowing a user to graphically modify one or more of the best-fit data points includes:
allowing the user to graphically modify the strike price coordinate of one or more of the best-fit data points.

9. The method of claim 6 further comprising:
assigning a weight to at least one of the modified best-fit data points that is greater than a weight assigned to a corresponding best-fit data point.

10. The method of claim 6 further comprising:
calculating one or more of a theoretical call value and a theoretical put value based, at least in part, upon one or more of the modified best-fit data points.

11. The method of claim 1 further comprising:
allowing a user to define the plurality of option sets.

12. The method of claim 1 wherein each of the plurality of option sets defines a unique chronological period.

13. A computer program product residing on a computer readable medium having a plurality of instructions stored thereon which, when executed by a processor, cause the processor to perform operations comprising:
processing, for each of the plurality of option sets, a group of initial data points, wherein each initial data point includes a strike price coordinate and a volatility coordinate; and
generating, on a single Cartesian plane and for each of the plurality of option sets, a best-fit curve based, at least in part, upon two or more of the initial data points included within the respective group, wherein each best-fit curve defines a plurality of best-fit data points, and wherein each best-fit data point includes a strike price coordinate and a volatility coordinate.

14. The computer program product of claim 13 wherein the volatility coordinate of at least one of the initial data points includes a blended volatility coordinate.

15. The computer program product of claim 13 wherein the volatility coordinate of at least one of the best-fit data points includes a blended volatility coordinate.

16. The computer program product of claim 13 wherein the instructions for generating, on a single Cartesian plane and for each of the plurality of option sets, a best-fit curve include instructions for:
defining, for each of the plurality of option sets, the plurality of best-fit data points with a curve fitting algorithm.

17. The computer program product of claim 16 wherein the curve fitting algorithm includes one or more of: a least-squares algorithm; a weighted least-squares algorithm; a robust least-squares algorithm; and a non-linear least-squares algorithm.

18. The computer program product of claim 13 further comprising instructions for:
allowing a user to graphically modify one or more of the best-fit data points to define one or more modified best-fit data points.

19. The computer program product of claim 18 wherein the instructions for allowing a user to graphically modify one or more of the best-fit data points include instructions for:
allowing the user to graphically modify the volatility coordinate of one or more of the best-fit data points.

20. The computer program product of claim 18 wherein the instructions for allowing a user to graphically modify one or more of the best-fit data points include instructions for:
allowing the user to graphically modify the strike price coordinate of one or more of the best-fit data points.

21. The computer program product of claim 18 further comprising instructions for:
assigning a weight to at least one of the modified best-fit data points that is greater than a weight assigned to a corresponding best-fit data point.

22. The computer program product of claim 18 further comprising instructions for:
calculating one or more of a theoretical call value and a theoretical put value based, at least in part, upon one or more of the modified best-fit data points.

23. The computer program product of claim 13 further comprising instructions for:
allowing a user to define the plurality of option sets.

24. The computer program product of claim 13 wherein each of the plurality of option sets defines a unique chronological period.

25. A client computer configured to perform operations comprising:
processing, for each of the plurality of option sets, a group of initial data points, wherein each initial data point includes a strike price coordinate and a volatility coordinate; and
generating, on a single Cartesian plane and for each of the plurality of option sets, a best-fit curve based, at least in part, upon two or more of the initial data points included within the respective group, wherein each best-fit curve defines a plurality of best-fit data points, and wherein each best-fit data point includes a strike price coordinate and a volatility coordinate.

26. The client computer of claim 25 wherein the volatility coordinate of at least one of the initial data points includes a blended volatility coordinate.

27. The client computer of claim 25 wherein the volatility coordinate of at least one of the best-fit data points includes a blended volatility coordinate.

28. The client computer of claim 25 wherein generating, on a single Cartesian plane and for each of the plurality of option sets, a best-fit curve includes:
defining, for each of the plurality of option sets, the plurality of best-fit data points with a curve fitting algorithm.

29. The client computer of claim 28 wherein the curve fitting algorithm includes one or more of: a least-squares algorithm; a weighted least-squares algorithm; a robust least-squares algorithm; and a non-linear least-squares algorithm.

30. The client computer of claim 25, wherein the client computer is further configured for:
allowing a user to graphically modify one or more of the best-fit data points to define one or more modified best-fit data points.

31. The client computer of claim 30 wherein allowing a user to graphically modify one or more of the best-fit data points includes:
allowing the user to graphically modify the volatility coordinate of one or more of the best-fit data points.

32. The client computer of claim 30 wherein allowing a user to graphically modify one or more of the best-fit data points includes:
allowing the user to graphically modify the strike price coordinate of one or more of the best-fit data points.

33. The client computer of claim 30, wherein the client computer is further configured for:
assigning a weight to at least one of the modified best-fit data points that is greater than a weight assigned to a corresponding best-fit data point.

34. The client computer of claim 30, wherein the client computer is further configured for:
calculating one or more of a theoretical call value and a theoretical put value based, at least in part, upon one or more of the modified best-fit data points.

35. The client computer of claim 25, wherein the client computer is further configured for:
allowing a user to define the plurality of option sets.

36. The client computer of claim 25 wherein each of the plurality of option sets defines a unique chronological period.
